(19) United States
(12) Patent Application Publication
(10) Pub. No.: US 2024/0077062 A1
(43) Pub. Date: Mar. 7, 2024

(54) CONSTRUCTION METHOD OF BENCHMARK STATE SPACE MODEL FOR OFFSHORE WIND TURBINE

(71) Applicant: Harbin Institute of Technology, Shenzhen, Shenzhen (CN)

(72) Inventors: Ying WANG, Shenzhen (CN); Jun LIANG, Shenzhen (CN)

(73) Assignee: Harbin Institute of Technology, Shenzhen, Shenzhen (CN)

(21) Appl. No.: 18/236,992

(22) Filed: Aug. 23, 2023

(30) Foreign Application Priority Data
Aug. 24, 2022 (CN) 202211021700.X

(51) Int. Cl. F03D 17/00; G06F 30/17; G06F 30/23

(52) U.S. Cl. CPC F03D 17/015; G06F 30/17; G06F 30/23; G06F 2111/10

(57) ABSTRACT

A benchmark state space model construction method for an offshore wind turbine is provided. The benchmark state space model is constructed by the modal information of the first several orders of the high-order finite element model of the offshore wind turbine. Since the benchmark state space model is only established by the first several orders of the high-order finite element model, the time domain analysis of the offshore wind turbine using the benchmark state space model instead of the high-order finite element model can improve the calculation efficiency and reduce the calculation cost. The benchmark state space model construction method solves the problem of low computational efficiency and high computational cost of time domain analysis of offshore wind turbines using high-order finite element models due to the excessive number of high-order finite element units in existing technologies.

### CROSS REFERENCE TO THE RELATED APPLICATIONS

This application is based upon and claims priority to Chinese Patent Application No. 202211021700.X, filed on Aug. 24, 2022, the entire contents of which are incorporated herein by reference

### TECHNICAL FIELD

The present invention relates to the technical field of offshore wind turbines, in particular to a construction method of benchmark state space model for offshore wind turbine.

### BACKGROUND

The dynamic characteristics of offshore wind turbines are complex, so high-order finite element models are often used to simulate the dynamic characteristics of monopile offshore wind turbines. However, the number of traditional high-order finite element elements is too large and the calculation efficiency is low. Therefore, it is difficult and costly to use high-order finite element model to analyze offshore wind turbines in time domain. Therefore, the existing technology needs to be improved and developed.

### SUMMARY

The technical problem to be solved by the present invention is to provide a benchmark state space model construction method for offshore wind turbines in view of the above defects of the existing technology, in the existing technology, due to the large number of high-order finite element units, the high-order finite element model is used to solve the problem of low efficiency and high cost of time domain analysis and calculation of offshore wind turbines.

The technical scheme adopted by the present invention to solve the problem is as follows:
in the first aspect, the embodiment of the present invention provides a method for constructing a benchmark state space model of an offshore wind turbine, wherein the method includes:
respectively obtaining a modal information corresponding to a high-order finite element model of the offshore wind turbine and first several target orders of the high-order finite element model, wherein the high-order finite element model is a dynamic analysis model whose number of elements is greater than a preset value;
according to the modal information corresponding to each target order, determining a vibration mode matrix and a diagonal matrix in a regular coordinate system;
determining a transformation matrix according to the vibration mode matrix, and determining a target motion equation of the offshore wind turbine in the regular coordinate system according to the transformation matrix and the diagonal matrix, wherein the transformation matrix is used to reflect a transformation relationship between a generalized coordinate system and the regular coordinate system; and
according to the target motion equation, determining the benchmark state space model corresponding to the offshore wind turbine, wherein the benchmark state space model is used to reflect the relationship between a load and a time domain response of the offshore wind turbine in the regular coordinate system;

Secondly, the embodiment of the present invention also provides a construction device for a benchmark state space model of an offshore wind turbine, wherein the device includes:
an information acquisition module, wherein the information acquisition module is used to obtain a modal information corresponding to a high-order finite element model of the offshore wind turbine and first several target orders of the high-order finite element model, wherein the high-order finite element model is a dynamic analysis model with a larger number of elements than a preset value;
a matrix determination module, wherein the matrix determination module is used to determine a vibration mode matrix and a diagonal matrix in a regular coordinate system according to the modal information corresponding to the order of each target;
an equation determination module is used to determine the transformation matrix accordian equation determination module, wherein the equation determination module is used to determine a transformation matrix according to the vibration mode matrix, and to determine a target motion equation of the offshore wind turbine in the regular coordinate system according to the transformation matrix and the diagonal matrix, wherein the transformation matrix is used to reflect a transformation relationship between a generalized coordinate system and the regular coordinate system; and
a model building module, wherein the model building module is used to determine the benchmark state space model corresponding to the offshore wind turbine according to the target motion equation, wherein the benchmark state space model is used to reflect a relationship between a load and a time domain response of the offshore wind turbine in the regular coordinate system.

In the third aspect, the embodiment of the present invention also provides a terminal, which includes a memory and more than one processor; wherein the memory stores more than one program, the more than one program contains instructions for performing the construction method of the benchmark state space model for the offshore wind turbine as described any of the above, and the processor is used to execute the more than one program.

Fourthly, the embodiment of the invention also provides a computer readable storage medium, storing a plurality of instructions, wherein the plurality of instructions are configured to be loaded and executed by a processor to implement steps of the construction method of the benchmark state space model for the offshore wind turbine as described any of the above.

The beneficial effects of the present invention are as follows: the embodiment of the invention constructs a benchmark state space model through the modal information of the first several orders of the high-order finite element model of the offshore wind turbine, since the benchmark state space model is only established by the first several order modal information of the high order finite element model, the time domain analysis of the offshore wind turbine can be improved by using the benchmark state space model instead of the high order finite element model, reducing computing costs. It solves the problem of low computational efficiency and high computational cost of time domain analysis of offshore wind turbines using high-order finite element models due to the excessive number of high-order finite element units in existing technologies.

### BRIEF DESCRIPTION OF THE DRAWINGS

In order to more clearly explain the technical scheme in the embodiment or the existing technology of the invention, the following will briefly introduce the drawings that need to be used in the embodiment or the existing technology description. Obviously, the drawings in the following description are only some embodiments recorded in the invention. For ordinary technicians in this field, they can also obtain other drawings based on these drawings without paying creative labor.

FIG. 1 is a flow diagram of the benchmark state space model construction method of the offshore wind turbine provided by the embodiment of the present invention.

FIG. 2 is a high-order finite element model of a single-pile offshore wind turbine provided by the embodiment of the present invention.

FIG. 3 is a random load curve provided by the embodiment of the present invention.

FIG. 4 is a comparison of the displacement response at the vertex of the blade between the high-order finite element model and the benchmark state space model provided by the embodiment of the present invention.

FIG. 5 is a comparison of the displacement response at the middle of the tower between the high-order finite element model and the benchmark state space model provided by the embodiment of the invention.

FIG. 6 is a comparison of the displacement response at the vertex of the blade between the high-order finite element model provided by the embodiment of the invention and the benchmark state space model established by using different order (20,16,12,8,4) modal information

FIG. 7 is a comparison of the displacement response at the middle of the tower between the high-order finite element model provided by the embodiment of the invention and the benchmark state space model established by modal information of different orders (20,16,12,8,4).

FIG. 8 is a comparison of the displacement response at the vertex of the blade between the high-order finite element model provided by the embodiment of the invention and the benchmark state space model established by using different order (8,7,6,5,4) modal information.

FIG. 9 is a comparison of the displacement response at the middle of the tower between the high-order finite element model provided by the embodiment of the invention and the benchmark state space model established by using different order (8,7,6,5,4) modal information.

FIG. 10 is a module diagram of the construction device of the benchmark state space model of the offshore wind turbine provided by the embodiment of the invention.

FIG. 11 is a schematic diagram of the terminal provided by the embodiment of the invention.

### DETAILED DESCRIPTION OF THE EMBODIMENTS

The present invention discloses a method for constructing a benchmark state space model of an offshore wind turbine. In order to make the purpose, technical scheme and effect of the invention more clear and definite, the following reference is made to the attached figure and an implementation example to further explain the invention in detail. It should be understood that the specific implementation examples described here are only used to explain the invention and are not used to limit the present invention.

Technicians in the technical field can understand that the singular forms ‘one’, ‘one’, ‘stated’ and ‘that’ used here can also include plural forms unless specifically stated. It should be further understood that the wording ‘including’ used in the specification of the present invention refers to the presence of said features, integers, steps, operations, components and/or components, but does not preclude the presence or addition of one or more other features, integers, steps, operations, components, components and/or their groups. It should be understood that when we call a component ‘connected’ or ‘coupled’ to another component, it can be directly connected or coupled to other components, or there can be intermediate components. In addition, the ‘connection’ or ‘coupling’ used here can include wireless connection or wireless coupling. The wording ‘and/or’ used here includes all or any of the units and all combinations of one or more associated listed items.

Technicians in this technical field can understand that, unless otherwise defined, all the terms used here (including technical terms and scientific terms) have the same meaning as the general understanding of ordinary technicians in the field to which the invention belongs. It should also be understood that terms such as those defined in the general dictionary should be understood to have meanings consistent with those in the context of existing technologies, and will not be interpreted in an idealized or overly formal sense unless specifically defined as here.

In view of the above defects of the existing technology, the present invention provides a method for constructing the benchmark state space model of the offshore wind turbine. The method obtains the modal information corresponding to the high-order finite element model corresponding to the offshore wind turbine and the first several target orders of the high-order finite element model. Among them, the high-order finite element model is a dynamic analysis model with a larger number of elements than the preset value; according to the modal information corresponding to the order of each target, the vibration mode matrix and diagonal matrix in the regular coordinate system are determined. The transformation matrix is determined according to the vibration mode matrix, and the target motion equation of the offshore wind turbine in the regular coordinate system is determined according to the transformation matrix and the diagonal matrix The transformation matrix is used to reflect the transformation relationship between the generalized coordinate system and the regular coordinate system. According to the target motion equation, the benchmark state space model corresponding to the offshore wind turbine is determined. The benchmark state space model is used to reflect the relationship between the load and the time domain response of the offshore wind turbine in the regular coordinate system. The invention constructs the benchmark state space model through the modal information of the first several orders of the high-order finite element model of the offshore wind turbine. Since the benchmark state space model is only established by the first several orders of the high-order finite element model, the benchmark state space model is used instead of the high-order finite element model for the time domain analysis of the offshore wind turbine, which can improve the calculation efficiency and reduce the calculation cost. It solves the problem of low computational efficiency and high computational cost of time domain analysis of offshore wind turbines using high-order finite element models due to the excessive number of high-order finite element units in existing technologies.

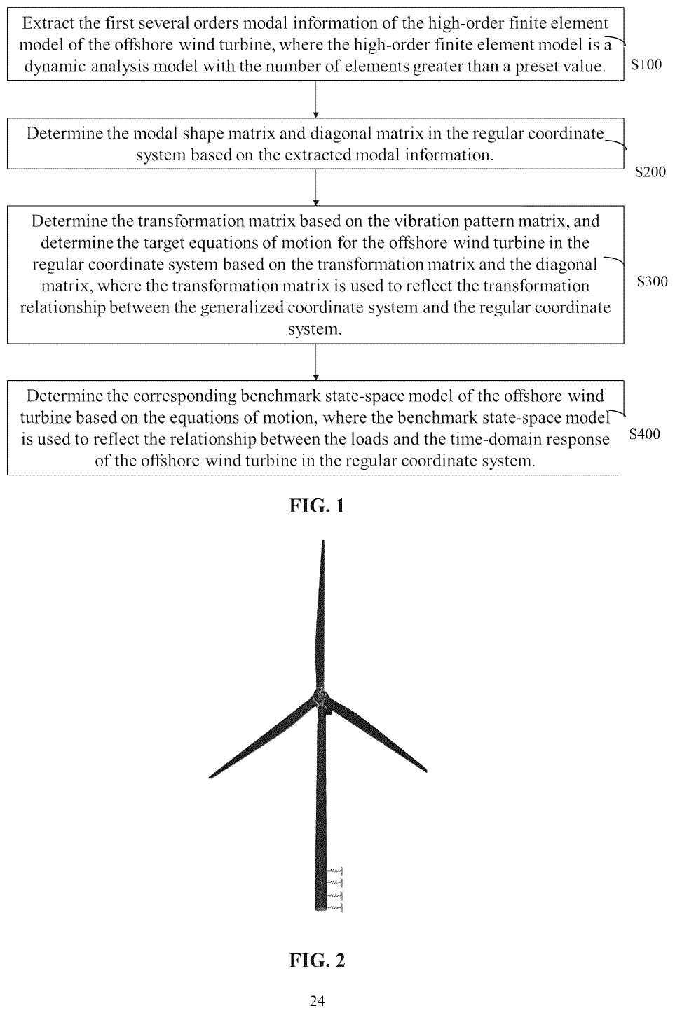

As shown in FIG. 1, the method includes the following steps:
Step S100. obtaining the modal information corresponding to the high-order finite element model of the offshore wind turbine and the first several target orders of the high-order finite element model, where, the high-order finite element model is a dynamic analysis model whose element number is greater than the preset value.

Specifically, the high-order finite element model of offshore wind turbines is a complex model based on the actual structure of offshore wind turbines, so the high-order finite element model has a large number of different types of elements, for example, DTU 10 MW offshore wind turbine has 61080 different types of units. In order to reduce the number of elements, this example only extracts the modal information of the first several target orders of the high-order finite element model to construct the benchmark state space model, where the modal information includes frequency and vibration mode. For example, the benchmark state space model of offshore wind turbines is constructed by extracting the first five-order frequencies and modes of the high-order finite element model to improve the computational efficiency of the model.

As shown in FIG. 1, the method also includes the following steps:
Step S200. according to the modal information corresponding to each target order, the vibration mode matrix and diagonal matrix in the regular coordinate system are determined.

Specifically, since the modal information includes frequency and mode shape, the diagonal matrix can be determined according to the frequencies corresponding to each target order, where the frequencies corresponding to each target order are successively located on the diagonal of the diagonal matrix. According to the corresponding vibration modes of each target order, the vibration mode matrix is constructed.

For example, the first m-order frequency ωₘᵢ of the high-order finite element model is extracted, and then the diagonal matrix [A] is constructed according to the first m-order frequency ωₘᵢ.

$$[ \begin{matrix}{ω}_{n 1}^{2} & & \\ & ⋱ & \\ & & {ω}_{n m}^{2}\end{matrix} ] = [ Λ ] ; \qquad ( 1 )$$

where, ωₙₘ² is the m-th order frequency of the structure

The first m-order vibration mode vectors (i=1, 2, . . . , m) of the high-order finite element model of offshore wind turbine are extracted, and the vibration mode matrix (Formula 3) in regular coordinates is obtained according to Formula (2).

$${\{ Φ \}}_{i} = \frac{1}{\sqrt{{M}_{i}}} {\{ u \}}_{i} ; \qquad ( 2 )$$

$${[ Φ ]}_{q \times m} = \{ {\{ Φ \}}_{1} {\{ Φ \}}_{2} … {\{ Φ \}}_{m} \} ; \qquad ( 3 )$$

where, {Φ}ₗ is the vibration mode vector under the regular coordinate, {Φ} is the vibration mode matrix, and the subscript q represents the order of the vibration mode vector, that is, the number of selected degrees of freedom.

As shown in FIG. 1, the method also includes the following steps:
Step S300, determining the transformation matrix according to the vibration mode matrix, and determining the target motion equation of the offshore wind turbine in the regular coordinate system according to the transformation matrix and the diagonal matrix, where the transformation matrix is used to reflect the transformation relationship between the generalized coordinate system and the regular coordinate system.

Specifically, according to the vibration mode matrix and the diagonal matrix, combined with the structural motion equation of the offshore wind turbine in the regular coordinate system, the motion equation of the offshore wind turbine can be derived, that is, the target motion equation is obtained, the relationship between load, displacement and acceleration of offshore wind turbine in regular coordinate system can be reflected by the target motion equation.

An example is given to illustrate that the formula (4) is obtained by using the mode shape matrix in regular coordinates as the transformation matrix:

{x₍ₜ₎}=[Φ]{z₍ₜ₎} (4);
wherein, {x₍ₜ₎} is the displacement vector of the structure under generalized coordinates, {z₍ₜ₎} is the displacement vector of the structure in regular coordinates.

Then, formula (4) is substituted into the structural motion equation of offshore wind turbine, by multiplying left {Φ}^{T} and removing the damping term, the formula (5) is obtained:

[Φ]^{T}[M][Φ]{\ddot{z}}+[Φ]^{T}[K][Φ]{z}=[Φ]^{T}{F(t)} (5);
where, [M] is the mass matrix of the structure, [K] is the stiffness matrix of the structure, {F(t)} is the load of structure in generalized coordinates, [Φ]T is the transpose of the vibration mode matrix [Φ]; {\ddot{z}} is the acceleration response in regular coordinates, {z} the displacement response in regular coordinates. According to Formula (5), we can get:

$${[ Φ ]}^{T} [ M ] [ Φ ] = [ I ] ; \qquad ( 6 )$$

$${[ Φ ]}^{T} [ K ] [ Φ ] = [ \begin{matrix}{ω}_{n 1}^{2} & & \\ & ⋱ & \\ & & {ω}_{n m}^{2}\end{matrix} ] = [ Λ ] ; \qquad ( 7 )$$

wherein, [I] is a unit diagonal matrix, ωₙₘ² is the mth-order frequency of the structure, [A] is a diagonal matrix composed of the first m-order frequencies of the structure.

In addition, according to the transformation matrix, the formula (8) can also be obtained:

{P(t)}=[ϕ]^{T}{F(t)} (8);
wherein {F(t)} is the load of the structure in regular coordinates.

According to Formula (5) and Formula (8), the target motion equation of offshore wind turbine in regular coordinate system can be obtained (Formula 9):

(\ddot{Z})+[∧](Z)={P(t)} (9);
wherein, z is displacement; \ddot{Z} is the second derivative of displacement with respect to time, that is acceleration; P(t) is the load of offshore wind turbine in regular coordinate system. Therefore, the relationship between load, displacement and acceleration of offshore wind turbine in regular coordinate system can be obtained by diagonal matrix.

As shown in FIG. 1, the method also includes the following steps:
Step S400. according to the target motion equation, the benchmark state space model corresponding to the offshore wind turbine is determined, wherein, the benchmark state space model is used to reflect the relationship between the load and the time domain response of the offshore wind turbine in the regular coordinate system.

Specifically, since the target motion equation can reflect the relationship between the load, displacement and acceleration of the offshore wind turbine in the regular coordinate system, it is converted into a matrix form, that is, the benchmark state space model is obtained. The load of the offshore wind turbine in the regular coordinate system is input into the benchmark state space model. The benchmark state space model can output the corresponding time domain response data through the input load, so as to realize the time domain analysis of the offshore wind turbine.

In an implementation, the steps S300 specifically includes the following steps:
Step S301. According to the target motion equation, the continuous state space model corresponding to the offshore wind turbine is determined, wherein, the continuous state space model is used to reflect the relationship between the load and the time domain response of the offshore wind turbine in the regular coordinate system. The state variables corresponding to the continuous state space model are determined based on the displacement and velocity variables;
Step S302, the continuous state space model is discretized to obtain the benchmark state space model.

Specifically, this example can convert the target motion equation into an intermediate equation that reflects the relationship between the load and the state variables of the offshore wind turbine in the regular coordinate system by using the state variables composed of displacement variables and velocity variables. Since the velocity variable in the state variable is the first derivative of the corresponding displacement variable with respect to time, the intermediate equation is converted into a matrix form, that is, a continuous state space model is obtained. The input vector of the continuous state space model is the load of the offshore wind turbine in the regular coordinate system, the output vector is the corresponding time domain response data, and the state vector is determined based on the displacement vector and the velocity vector. In order to further improve the computational efficiency of the model, this example also needs to discretize the continuous state space model. The discrete model is used as the benchmark state space model, and the time domain analysis of offshore wind turbines can be carried out quickly and efficiently through the benchmark state model.

In an implementation method, the step S301 specifically includes the following steps:
Step S3011. determining the system matrix according to the target motion equation,
Step S3012. obtaining the preset input matrix and output matrix, and determining the continuous state space model according to the system matrix, the input matrix and the output matrix, wherein, the system matrix and the input matrix are used to reflect the relationship between the load of the offshore wind turbine and the state variable in the regular coordinate system, the output matrix is used to reflect the relationship between the state variable and the time domain response of the offshore wind turbine in the regular coordinate system.

Specifically, the key to construct a continuous state space model is to determine three matrices: system matrix, input matrix and output matrix. Among them, the input matrix and output matrix are pre-set, and the system matrix needs to be calculated based on the obtained diagonal matrix. Specifically, the system matrix contains multiple elements. In addition to the elements represented by the diagonal matrix corresponding to the target motion equation, the values of other elements are pre-set. Therefore, the system matrix is obtained by substituting the diagonal matrix corresponding to the target motion equation into its corresponding elements. Through the system matrix and the input matrix, the relationship equation between the load and the state variable of the offshore wind turbine in the regular coordinate system can be established. Through the output matrix, the relationship equation between the state variable and the time domain response of the offshore wind turbine in the regular coordinate system can be established. Finally, the continuous state space model based on the load prediction time domain response can be established through these two relationship equations.

For example, the state variable (formula 10) is selected, and then the formula (11) is transformed into the formula (12) according to the state variable. Finally, the formula (12) is written in matrix form to obtain a continuous state space model:

$$\{ \begin{matrix}{y}_{1} = z \\ {y}_{2} = \dot{z}\end{matrix} ;$$

$$\{ \begin{matrix}{\dot{y}}_{1} = {y}_{2} \\ {\dot{y}}_{2} = - [ Λ ] {y}_{1} + p ;\end{matrix}$$

$$\{ \begin{matrix}\dot{y} = [ \begin{matrix}0 & 1 \\ - Λ & 0\end{matrix} ] y + [ \begin{matrix}0 \\ 1\end{matrix} ] p \\ w = [ 10 ] y + [ 0 ] p\end{matrix}$$

wherein, is the state vector, is the input vector, is the output vector, so the system matrix, input matrix and output matrix in the continuous state space model are:

$${A}_{1} = [ \begin{matrix}0 & 1 \\ - Λ & 0\end{matrix} ] ; {B}_{1} = [ \begin{matrix}0 \\ 1\end{matrix} ] ; {C}_{1} = [ 10 ]$$

In an implementation, the steps S302 include the following steps:
Step S3021. the system matrix is discretized to obtain a discrete system matrix;
Step S3022. obtaining the unit diagonal matrix, where the unit diagonal matrix is a matrix with all 1 elements on the diagonal;
Step S3023. determining the discrete input matrix according to the system matrix, the discrete system matrix, the unit diagonal matrix and the input matrix;
Step S3024. According to the discrete system matrix, the discrete input matrix and the output matrix, the benchmark state space model is determined.

Specifically, in order to further reduce the computational cost of the model, this example needs to discretize the continuous state space model. Firstly, the system matrix is discretized to obtain the discrete system matrix:

A=exp (A₁Δt) (13);
wherein, the discrete system matrix.
then, according to the system matrix, discrete system matrix, unit diagonal matrix and input matrix, the discrete input matrix is determined:

B=A₁⁻¹(A−I)B₁ (14);
where, I is a unit diagonal matrix, Bis a discrete input matrix.

In addition, the output matrix is unchanged, that is :

C=C₁ (15);

Where, C is the output matrix corresponding to the benchmark state space model.

Finally, according to the discrete system matrix, discrete input matrix and output matrix, the discrete state space model can be determined, that is, the benchmark state space model:

$$\{ \begin{matrix}{y}_{i + 1} = {Ay}_{i} + {Bp}_{i} \\ w = Cy\end{matrix} . \qquad ( 16 )$$

In an implementation, the method also includes the following steps:
Step S10. Obtaining the target high-order finite element model and several candidate benchmark state space models corresponding to the test offshore wind turbine, wherein, each candidate benchmark state space model is established based on the modal information of the first several orders of the target high-order finite element model.
Step S20. obtaining the model accuracy corresponding to each of the candidate benchmark state space models.
Step S30. according to the accuracy of the model corresponding to each candidate benchmark state space model, the order of the first several targets is determined.

In short, because the prediction performance of the benchmark state model constructed by using different modal information of the first several orders is different, an experimental offshore wind turbine is pre-set in this implementation example. For example, the first offshore wind turbine to construct the benchmark state space model can be used as an experimental offshore wind turbine to determine the most suitable order combination. Specifically, the modal information of the first several orders of the high-order finite element model of the experimental offshore wind turbine is extracted to construct a candidate benchmark state space model. For example, the modal information of the first 4,5,6,7 and 8 orders is used to construct a candidate benchmark state space model, that is, five candidate benchmark state space models are obtained. For each candidate benchmark state space model, the model accuracy of the candidate benchmark state space model can be determined by comparing the deviation between the output of the candidate benchmark state space model and the output of the target high-order finite element model. Since the output of the candidate benchmark state space model corresponds to the regular coordinate system, and the output of the high-order finite element model corresponds to the generalized coordinate system, after obtaining the output of the candidate benchmark state space model, it is necessary to convert the corresponding output to the generalized coordinate system according to the transformation matrix of the candidate benchmark state space model, and then determine the model accuracy of the candidate benchmark state space model Finally, by comparing the model accuracy of each candidate benchmark state space model, the candidate benchmark state space model with appropriate model accuracy is selected, and its corresponding first several orders are taken as the first several target orders. When the next offshore wind turbine arrives, the modal information of the first several target orders of its corresponding high-order state space model can be directly extracted to construct its corresponding benchmark state space model.

In one implementation, the determination process of the model accuracy corresponding to each candidate benchmark state space model includes:
Step S21. According to the transformation matrix corresponding to each candidate benchmark state space model, the first time domain response data of the candidate benchmark state space model based on the generalized coordinate system generated by the target load is obtained;
Step S22. obtaining the second time domain response data of the target high-order finite element model based on the generalized coordinate system generated by the target load;
Step S23. According to the first time domain response data and the second time domain response data, the accuracy of the model corresponding to the candidate benchmark state space model is determined.

Specifically, for each candidate benchmark state space model, the time-domain response data generated by the candidate benchmark state space model and the target high-order finite element model based on the equivalent load are first obtained, wherein, the time-domain response data output by the candidate benchmark state space model is transformed into the first time-domain response data in the generalized coordinate system after the transformation matrix is transformed. The target high-order finite element model directly outputs the second time-domain response data in the generalized coordinate system. By comparing the deviation between the two time-domain response data, the model accuracy of the candidate benchmark state space model can be obtained.

An example is given to illustrate that for a candidate benchmark state space model, the time domain calculation is carried out according to the candidate benchmark state space model, and the time domain response of the candidate benchmark state space model under random load is obtained.

According to Formula (17), the time domain calculation results in the regular coordinate system are converted to the generalized coordinate system.

{x₍ₜ₎}=[Φ]{z₍ₜ₎} (17);

Then, it is compared with the time-domain calculation results of the high-order model under equivalent load to verify the model accuracy of the candidate benchmark state space model.

In an implementation, the method also includes the correction of the transformation matrix corresponding to each candidate benchmark state space model. The correction methods include:
Step S40. Determining whether the accuracy of the model is greater than the target value. If not, correct some of the first correction parameters and the second correction parameters in the transition matrix corresponding to the candidate benchmark state space model to obtain the correction matrix, wherein, some of the first correction parameters correspond to the vibration modes of the first several orders corresponding to the candidate benchmark state space model, and the second correction parameter corresponds to the transformation matrix of the candidate benchmark state space model.

Step S52, the correction matrix is used as the transformation matrix corresponding to the candidate benchmark state space model, and the model accuracy of the candidate benchmark state space model is continuously executed to determine whether the model accuracy is greater than the target value until the model accuracy is greater than the target value.

In simple terms, in order to improve the accuracy of the model, the implementation example can also modify the transformation matrix. Specifically, the first correction parameter corresponding to each mode in each transformation matrix and the second correction parameter corresponding to each transformation matrix are preset in this example. In other words, assuming that a transformation matrix includes m-order vibration modes, the corresponding correction parameters of the transformation matrix are m+1. For each transformation matrix, the objective function is established by the output of the candidate benchmark state space model corresponding to the transformation matrix and the output of the target high-order finite element model. The first correction parameter and the second correction parameter are corrected by the preset optimization algorithm/correction algorithm, so as to improve the model accuracy of each candidate benchmark state space model.

Understandably, in addition to modifying the transformation matrix of each candidate benchmark state space model, the transformation matrix of the benchmark state space model of the offshore wind turbine can also be modified. The correction method is similar, that is, the candidate benchmark state space model in the above step S50-52 is replaced by the benchmark state space model of the offshore wind turbine.

This implementation example takes DTU 10 MW fan as the test object to prove the technical effect of the present invention:
1. Firstly, a high-order finite element model of single-pile offshore wind turbine is established according to the relevant parameters of DTU 10 MW offshore wind turbine. As shown in FIG. 2, the model is built by 61080 different types of units
2. The first m-order frequency ωmi and vibration mode vector of the high-order finite element model of the monopile offshore wind turbine established in the previous step (in this implementation case, m takes 20,16,12,8,4,7,6,5 in turn) are extracted, and the vibration mode matrix [Φ]_{q×m} in the regular coordinate system is obtained according to the formula (3). In this paper, the high-order finite element model of single pile offshore wind turbine is selected every 10 m to select a section, and the mean value of the vibration mode data of all nodes in the section is taken as the vibration mode data of the section, a total of 52 sections, that is, q is 52×6. Finally, a vibration mode matrix of 312 rows and m columns is obtained.
3. The motion equation of the monopile offshore wind turbine in the regular coordinate system is established from the extracted modal information. The vibration mode matrix in the regular coordinate system is used as the transformation matrix;

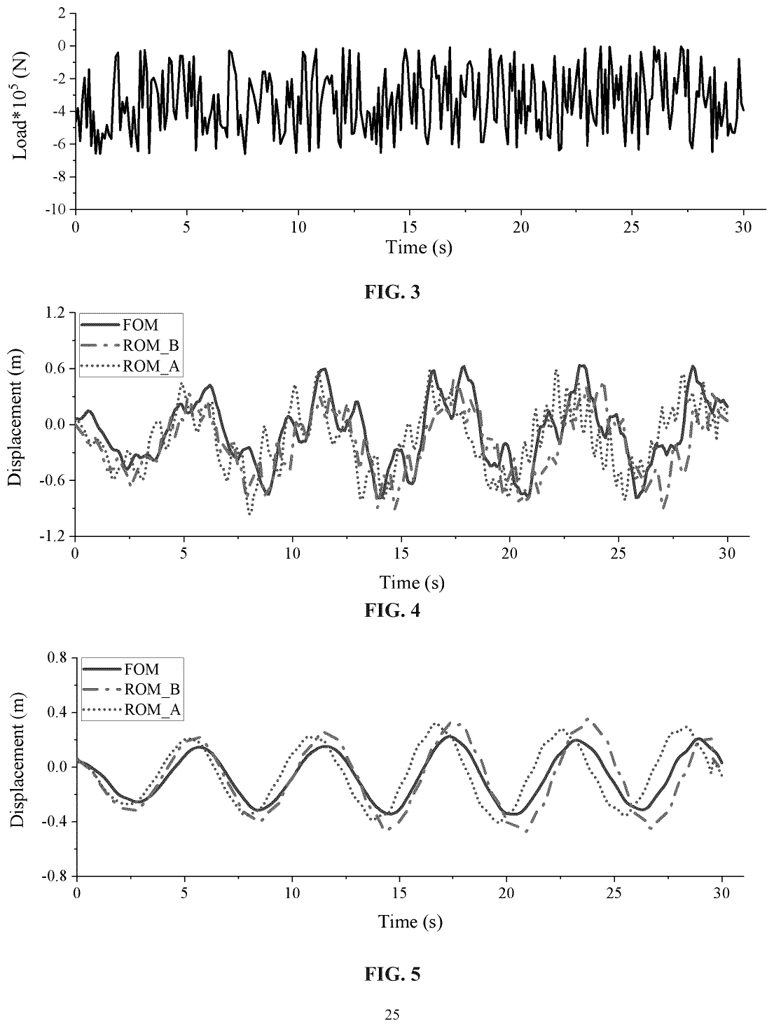

The formula (4) is substituted into the structural motion equation, and the formula (5) is obtained by multiplying the left side of the equation and removing the damping term. Formula (5) is transformed into Formula (9), which is the motion equation of monopile offshore wind turbine in regular coordinate system based on the extracted modal information.
4. The motion equation of the monopile offshore wind turbine in the regular coordinate system is transformed into a continuous state space model. First, the state variable (Formula 10) is selected, and then Formula (11) is converted into Formula (12) according to the state variable. Finally, Formula (12) is written into a matrix form to obtain a continuous state space model.
5. According to Formula (13-15), the continuous state space model is discretized, and the discrete state space model (Formula 16) is obtained.
6. The discrete state space model is used to calculate the time domain, and the time domain response of the state space model under random load (as shown in FIG. 3) is obtained;
7. Through the formula (17), the time domain calculation results in the regular coordinate system are converted to the generalized coordinate system. As shown in FIG. 4 and FIG. 5, the time-domain response of the high-order finite element model of the monopile offshore wind turbine and the benchmark state space model established by 20-order modal information under equivalent load is compared. Wherein, FIG. 4 is the displacement response at the vertex of the blade, and FIG. 5 is the displacement response at the middle of the tower. It can be seen from the figure that the benchmark state space model is in good agreement with the time domain results of the high-order finite element model.
8. In order to further improve the accuracy of the benchmark state space model, the vibration mode matrix is modified. A correction parameter is set for each mode shape of the mode shape matrix and a correction parameter is set for the whole mode shape matrix. Therefore, there are m+1 correction parameters. The time domain response data of the high-order finite element model and the time domain response of the benchmark state space model are used to establish the objective function. The optimization algorithm is the distribution estimation algorithm. As shown in FIG. 4 and FIG. 5, the time domain responses of the high-order finite element model and the benchmark state space model before and after correction are compared. The results show that the model correction can further reduce the deviation between the high-order finite element model and the benchmark state space model;

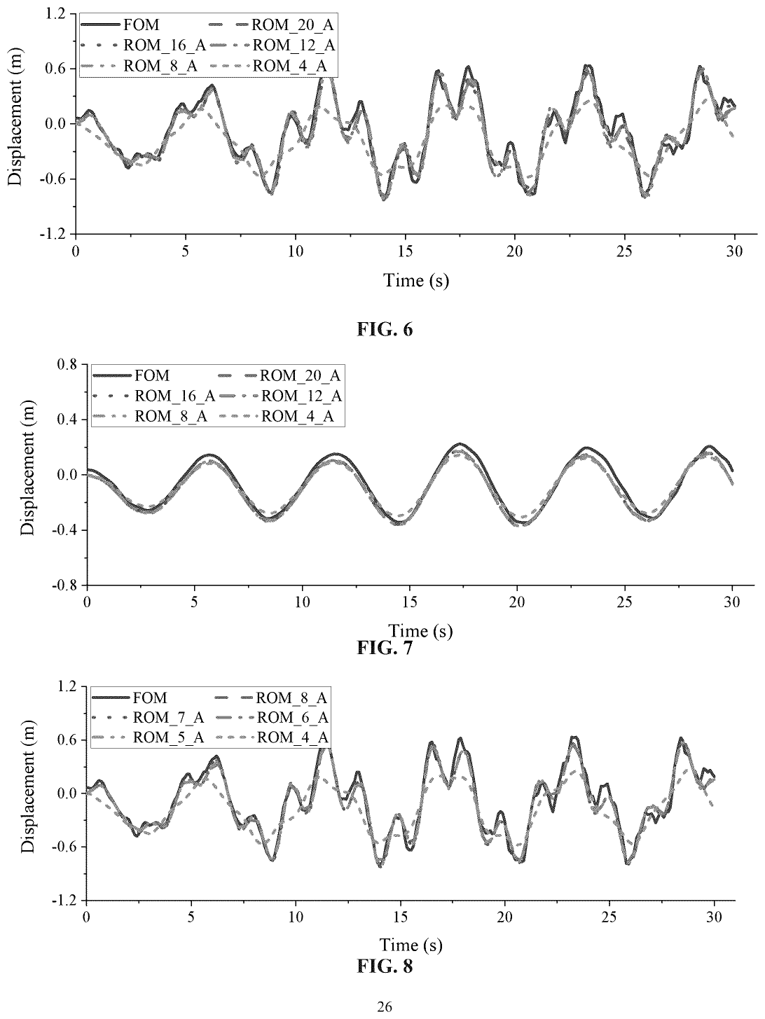

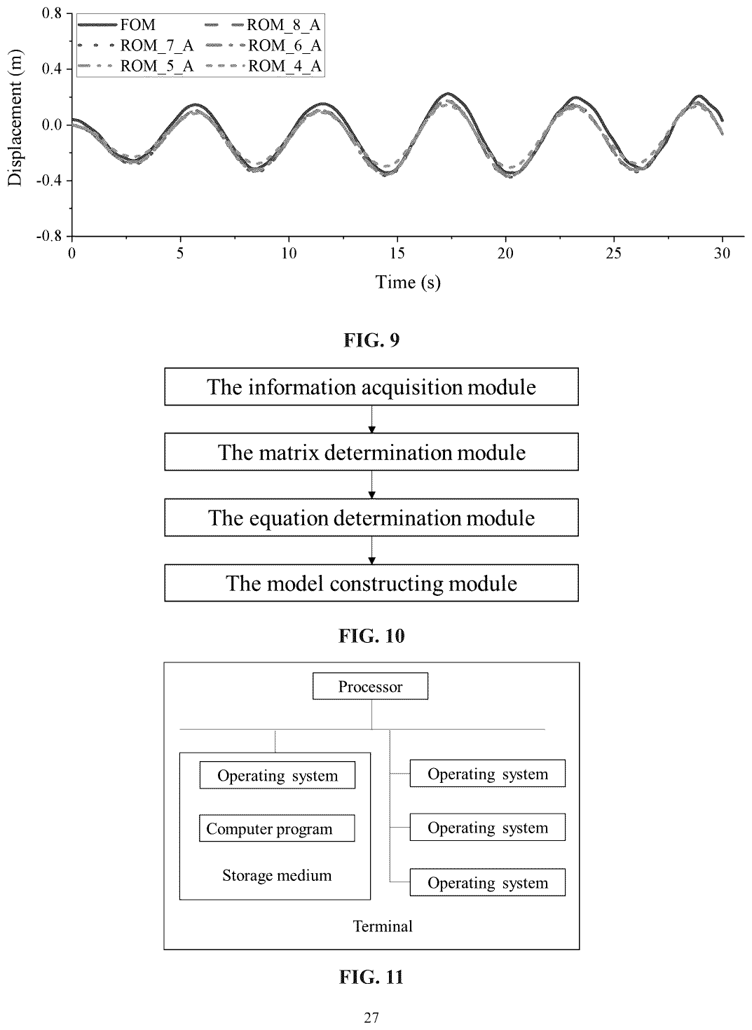

9. By changing m and repeating steps (2)-(8), the accuracy of establishing state space model with different order modal information is analyzed. As shown in FIG. 6 and FIG. 7, the time-domain calculation results of the high-order finite element model and the benchmark state space model established with different order (20,16,12,8,4) modal information are compared. The state space model established by the first 20,16,12 and 8 order modal information is in good agreement with the high order finite element model, while the state space model established by the first 4 order modal information has a large deviation from the high order finite element model. Therefore, as shown in FIG. 8 and FIG. 9, the state space model using the first 7,6 and 5 order modal information is established, and the time domain response of the high order finite element model and the benchmark state space model using different order (8,7,6,5,4) modal information is compared. The results show that the state space model established by at least 5 order modal information can be consistent with the time domain response of the high order finite element model.

The invention has the advantages of:
1. The benchmark state space model is only established by the first few modal information of the high-order finite element model, but its time domain response is highly consistent with the high-order finite element model, which can replace the high-order finite element model for related time domain analysis.
2. The established benchmark state space model can describe the state of the single-pile offshore wind turbine system in the form of minimum information. It does not require a lot of data, saves time and effort, and its mathematical model is simple.
3. The established benchmark state space model solves the problem of low computational efficiency of the traditional single-pile offshore wind turbine high-order finite clement model.
4. The vibration mode matrix is optimized by model updating, which further improves the time domain calculation accuracy of the benchmark state space model for offshore wind turbine dynamic analysis.

Based on the above implementation example, the invention also provides a construction device for a benchmark state space model of an offshore wind turbine, as shown in FIG. 10. The device includes:
The information acquisition module 01 is used to obtain the modal information corresponding to the high-order finite element model of the offshore wind turbine and the first several target orders of the high-order finite element model, respectively. The high-order finite element model is a dynamic analysis model with a larger number of elements than the preset value;
Matrix determination module 02 is used to determine the vibration mode matrix and diagonal matrix in the regular coordinate system according to the modal information corresponding to each target order;
The equation determination module 03 is used to determine the transformation matrix according to the vibration mode matrix, and the target motion equation of the offshore wind turbine in the regular coordinate system is determined according to the transformation matrix and the diagonal matrix. The transformation matrix is used to reflect the transformation relationship between the generalized coordinate system and the regular coordinate system;
The model construction module 04 is used to determine the benchmark state space model corresponding to the offshore wind turbine according to the target motion equation. The benchmark state space model is used to reflect the relationship between the load and the time domain response of the offshore wind turbine in the regular coordinate system.

Based on the above implementation examples, the invention also provides a terminal whose principle block diagram can be shown in FIG. 11. The terminal includes processor, memory, network interface and display screen connected by system bus. The processor of the terminal is used to provide computing and control capabilities. The terminal's memory includes non-volatile storage media and memory. The non-volatile storage medium stores operating systems and computer programs. The memory provides an environment for the operation of operating systems and computer programs in non-volatile storage media. The network interface of the terminal is used to communicate with the external terminal through the network connection. The computer program is executed by the processor to realize the construction method of the benchmark state space model of the offshore wind turbine. The display of the terminal can be a liquid crystal display or an electronic ink display.

The technical personnel in this field can understand that the principle block diagram shown in FIG. 11 is only a block diagram of the partial structure related to the invention scheme, which does not constitute a limit to the terminal applied to it by the invention scheme. The specific terminal can include more or less components than shown in the figure, or combine some components, or have different component arrangements.

In one implementation, more than one program is stored in the memory of the terminal, and configured to be executed by more than one processor to contain instructions for the construction method of the benchmark state space model of the offshore wind turbine.

The general technical personnel in this field can understand all or part of the process of implementing the above implementation method, which can be completed by computer program to instruct the relevant hardware. The computer program can be stored in a non-volatile computer readable storage medium. When the computer program is executed, it can include the process of the implementation of the above methods. Among them, any reference to memory, storage, database, or other media used in each embodiment provided by the invention may include non-volatile and/or volatile memory. Nonvolatile memory can include read-only memory (ROM), programmable ROM (PROM), electrically programmable ROM (EPROM), electrically erasable programmable ROM (EEPROM) or flash memory. The volatile memory can include random access memory (RAM) or external high-speed buffer memory. As an illustration rather than a limitation, RAM is available in a variety of forms, such as static RAM (SRAM), dynamic RAM (DRAM), synchronous DRAM (SDRAM), dual data rate SDRAM (DDRSDRAM), enhanced SDRAM (ESDRAM), synchronous link DRAM (SLDRAM), memory bus direct RAM (RDRAM), direct memory bus dynamic RAM (DRDRAM), and memory bus dynamic RAM (RDRAM).

In summary, the invention discloses a method for constructing a benchmark state space model of an offshore wind turbine. The method obtains the modal information corresponding to the high-order finite element model of the offshore wind turbine and the first several target orders of the high-order finite element model. Wherein, the high-order finite element model is a dynamic analysis model with a larger number of elements than the preset value; according to the modal information corresponding to each target order, the vibration mode matrix and diagonal matrix in the regular coordinate system are determined, the transformation matrix is determined according to the vibration mode matrix, and the target motion equation of the offshore wind turbine in the regular coordinate system is determined according to the transformation matrix and the diagonal matrix The transformation matrix is used to reflect the transformation relationship between the generalized coordinate system and the regular coordinate system; according to the target motion equation, the benchmark state space model corresponding to the offshore wind turbine is determined. The benchmark state space model is used to reflect the relationship between the load and the time domain response of the offshore wind turbine in the regular coordinate system. The invention constructs the benchmark state space model through the modal information of the first several orders of the high-order finite element model of the offshore wind turbine. Since the benchmark state space model is only established by the first several orders of the high-order finite element model, the benchmark state space model is used instead of the high-order finite element model for the time domain analysis of the offshore wind turbine, which can improve the calculation efficiency and reduce the calculation cost. It solves the problem of low computational efficiency and high computational cost of time domain analysis of offshore wind turbines using high-order finite element models due to the excessive number of high-order finite element units in existing technologies.

It should be understood that the application of the invention is not limited to the above examples. For ordinary technicians in this field, they can be improved or transformed according to the above instructions. All these improvements and transformations should belong to the scope of protection of the claims attached to the invention.

What is claimed is:

1. A construction method of a benchmark state space model for an offshore wind turbine, comprising:
respectively obtaining a modal information corresponding to a high-order finite element model of the offshore wind turbine and first several target orders of the high-order finite element model, wherein the high-order finite element model is a dynamic analysis model whose number of elements is greater than a preset value;
according to the modal information corresponding to each target order, determining a vibration mode matrix and a diagonal matrix in a regular coordinate system;
determining a transformation matrix according to the vibration mode matrix, and determining a target motion equation of the offshore wind turbine in the regular coordinate system according to the transformation matrix and the diagonal matrix, wherein the transformation matrix is used to reflect a transformation relationship between a generalized coordinate system and a regular coordinate system; and
according to the target motion equation, determining the benchmark state space model corresponding to the offshore wind turbine, wherein the benchmark state space model is used to reflect the relationship between a load and a time domain response of the offshore wind turbine in the regular coordinate system;
wherein the step of according to the target motion equation, determining the benchmark state space model corresponding to the offshore wind turbine, comprises:
according to the target motion equation, determining a continuous state space model corresponding to the offshore wind turbine, wherein the continuous state space model is used to reflect the relationship between the load and the time domain response of the offshore wind turbine in the regular coordinate system; and determining state variables corresponding to the continuous state space model based on the determination of displacement variables and velocity variables; and
discretizing the continuous state space model to obtain the benchmark state space model.

2. The construction method of the benchmark state space model for the offshore wind turbine according to claim 1, wherein the step of according to the target motion equation, determining the continuous state space model corresponding to the offshore wind turbine, comprises:
according to the target motion equation, determining a system matrix, and obtaining a preset input matrix and output matrix, and determining the continuous state space model according to the system matrix, the input matrix and the output matrix, wherein the system matrix and the input matrix are used to reflect the relationship between the load of the offshore wind turbine and the state variable in the regular coordinate system, and the output matrix is used to reflect the relationship between the state variable and the time domain response of the offshore wind turbine in the regular coordinate system.

3. The construction method of the benchmark state space model for the offshore wind turbine according to claim 2, wherein the step of discretizing the continuous state space model to obtain the benchmark state space model comprises:
discretizing the system matrix to obtain a discrete system matrix;
obtaining a unit diagonal matrix, wherein the unit diagonal matrix is a matrix with all 1 elements on a diagonal line;
according to the system matrix, the discrete system matrix, the unit diagonal matrix and the input matrix, determining a discrete input matrix; and
according to the discrete system matrix, the discrete input matrix and the output matrix, determining the benchmark state space model.

4. The construction method of the benchmark state space model for the offshore wind turbine according to claim 1, further comprises:
obtaining a target high-order finite element model and several candidate benchmark state space models corresponding to the test offshore wind turbine, wherein each candidate benchmark state space model is established based on the modal information of first several orders of the target high-order finite element model;
obtaining a model accuracy corresponding to each candidate benchmark state space model; and
according to the model accuracy corresponding to each candidate benchmark state space model, determining an order of the first several targets.

5. The construction method of the benchmark state space model for the offshore wind turbine according to claim 4, wherein a process of determining the model accuracy corresponding to each candidate benchmark state space model comprises:
according to the candidate benchmark state space model, obtaining first time domain response data based on the generalized coordinate system generated by a target load;
according to the target high-order finite element model, obtaining second time domain response data in the generalized coordinate system generated by the target load; and
according to the first time domain response data and the second time domain response data, determining the model accuracy corresponding to the candidate benchmark state space model.

6. The construction method of the benchmark state space model for the offshore wind turbine according to claim 4, further comprises:
judging whether the model accuracy is greater than a target value, if not, modifying some of first correction parameters and second correction parameters in the transformation matrix corresponding to the candidate benchmark state space model to obtain a correction matrix, wherein some of the first correction parameters correspond to the vibration modes of the first several orders of the candidate benchmark state space model, and the second correction parameters correspond to the transformation matrix of the candidate benchmark state space model; and
taking the correction matrix as the transformation matrix corresponding to the candidate benchmark state space model, obtaining the model accuracy of the candidate benchmark state space model, and continuing the step of judging whether the model accuracy is greater than the target value until the model accuracy is greater than the target value.

7. A construction device for a benchmark state space model of an offshore wind turbine, comprising:
an information acquisition module, wherein the information acquisition module is used to obtain a modal information corresponding to a high-order finite element model of the offshore wind turbine and first several target orders of the high-order finite element model, wherein the high-order finite element model is a dynamic analysis model with a larger number of elements than a preset value:
a matrix determination module, wherein the matrix determination module is used to determine a vibration mode matrix and a diagonal matrix in a regular coordinate system according to the modal information corresponding to the order of each target;
an equation determination module, wherein the equation determination module is used to determine a transformation matrix according to the vibration mode matrix, and to determine a target motion equation of the offshore wind turbine in the regular coordinate system according to the transformation matrix and the diagonal matrix, wherein the transformation matrix is used to reflect a transformation relationship between a generalized coordinate system and the regular coordinate system; and
a model building module, wherein the model building module is used to determine the benchmark state space model corresponding to the offshore wind turbine according to the target motion equation, wherein the benchmark state space model is used to reflect a relationship between a load and a time domain response of the offshore wind turbine in the regular coordinate system;
wherein the step of according to the target motion equation, determining the benchmark state space model corresponding to the offshore wind turbine, comprises:
according to the target motion equation, determining a continuous state space model corresponding to the offshore wind turbine, wherein the continuous state space model is used to reflect the relationship between the load and the time domain response of the offshore wind turbine in the regular coordinate system, and state variables corresponding to the continuous state space model are determined based on displacement variables and velocity variables; and
discretizing the continuous state space model to obtain the benchmark state space model

8. A terminal, comprises a memory and more than one processor; wherein the memory stores more than one program; the more than one program contains instructions for performing the construction method of the benchmark state space model for the offshore wind turbine according to claim 1, and the processor is used to execute the more than one program.

9. A computer readable storage medium, storing a plurality of instructions, wherein the plurality of instructions are configured to be loaded and executed by a processor to implement steps of the construction method of the benchmark state space model for the offshore wind turbine according to claim 1.

10. The terminal according to claim 8, wherein in the construction method of the benchmark state space model for the offshore wind turbine, the step of according to the target motion equation, determining the continuous state space model corresponding to the offshore wind turbine, comprises:
according to the target motion equation, determining a system matrix; and
obtaining a preset input matrix and output matrix, and determining the continuous state space model according to the system matrix, the input matrix and the output matrix, wherein the system matrix and the input matrix are used to reflect the relationship between the load of the offshore wind turbine and the state variable in the regular coordinate system, and the output matrix is used to reflect the relationship between the state variable and the time domain response of the offshore wind turbine in the regular coordinate system.

11. The terminal according to claim 10, wherein in the construction method of the benchmark state space model for the offshore wind turbine, the step of discretizing the continuous state space model to obtain the benchmark state space model comprises:
discretizing the system matrix to obtain a discrete system matrix;
obtaining a unit diagonal matrix, wherein the unit diagonal matrix is a matrix with all 1 elements on a diagonal line;
according to the system matrix, the discrete system matrix, the unit diagonal matrix and the input matrix, determining a discrete input matrix; and
according to the discrete system matrix, the discrete input matrix and the output matrix, determining the benchmark state space model.

12. The terminal according to claim 8, wherein the construction method of the benchmark state space model for the offshore wind turbine further comprises:
obtaining a target high-order finite element model and several candidate benchmark state space models corresponding to the test offshore wind turbine, wherein each candidate benchmark state space model is established based on the modal information of first several orders of the target high-order finite element model;
obtaining a model accuracy corresponding to each candidate benchmark state space model; and
according to the model accuracy corresponding to each candidate benchmark state space model, determining an order of the first several targets.

13. The terminal according to claim 12, wherein in the construction method of the benchmark state space model for the offshore wind turbine, a process of determining the model accuracy corresponding to each candidate benchmark state space model comprises:
according to the candidate benchmark state space model, obtaining first time domain response data based on the generalized coordinate system generated by a target load;
according to the target high-order finite element model, obtaining second time domain response data in the generalized coordinate system generated by the target load; and
according to the first time domain response data and the second time domain response data, determining the model accuracy corresponding to the candidate benchmark state space model.

14. The terminal according to claim 12, wherein the construction method of the benchmark state space model for the offshore wind turbine further comprises:
judging whether the model accuracy is greater than a target value, if not, modifying some of first correction parameters and second correction parameters in the transformation matrix corresponding to the candidate benchmark state space model to obtain a correction matrix, wherein some of the first correction parameters correspond to the vibration modes of the first several orders of the candidate benchmark state space model, and the second correction parameters correspond to the transformation matrix of the candidate benchmark state space model; and
taking the correction matrix as the transformation matrix corresponding to the candidate benchmark state space model, obtaining the model accuracy of the candidate benchmark state space model, and continuing the step of judging whether the model accuracy is greater than the target value until the model accuracy is greater than the target value.

15. The computer readable storage medium according to claim 9, wherein in the construction method of the benchmark state space model for the offshore wind turbine, the step of according to the target motion equation, determining the continuous state space model corresponding to the offshore wind turbine, comprises:
according to the target motion equation, determining a system matrix, and obtaining a preset input matrix and output matrix, and determining the continuous state space model according to the system matrix, the input matrix and the output matrix, wherein the system matrix and the input matrix are used to reflect the relationship between the load of the offshore wind turbine and the state variable in the regular coordinate system, and the output matrix is used to reflect the relationship between the state variable and the time domain response of the offshore wind turbine in the regular coordinate system.

16. The computer readable storage medium according to claim 15, wherein in the construction method of the benchmark state space model for the offshore wind turbine, the step of discretizing the continuous state space model to obtain the benchmark state space model comprises:
discretizing the system matrix to obtain a discrete system matrix;
obtaining a unit diagonal matrix, wherein the unit diagonal matrix is a matrix with all 1 elements on a diagonal line;
according to the system matrix, the discrete system matrix, the unit diagonal matrix and the input matrix, determining a discrete input matrix; and
according to the discrete system matrix, the discrete input matrix and the output matrix, determining the benchmark state space model.

17. The computer readable storage medium according to claim 9, wherein the construction method of the benchmark state space model for the offshore wind turbine further comprises:
obtaining a target high-order finite element model and several candidate benchmark state space models corresponding to the test offshore wind turbine, wherein each candidate benchmark state space model is established based on the modal information of first several orders of the target high-order finite element model;
obtaining a model accuracy corresponding to each candidate benchmark state space model; and
according to the model accuracy corresponding to each candidate benchmark state space model, determining an order of the first several targets.

18. The computer readable storage medium according to claim 17, wherein in the construction method of the benchmark state space model for the offshore wind turbine, a process of determining the model accuracy corresponding to each candidate benchmark state space model comprises:
according to the candidate benchmark state space model, obtaining first time domain response data based on the generalized coordinate system generated by a target load;
according to the target high-order finite element model, obtaining second time domain response data in the generalized coordinate system generated by the target load; and
according to the first time domain response data and the second time domain response data, determining the model accuracy corresponding to the candidate benchmark state space model.

19. The computer readable storage medium according to claim 17, wherein the construction method of the benchmark state space model for the offshore wind turbine further comprises:
judging whether the model accuracy is greater than a target value, if not, modifying some of first correction parameters and second correction parameters in the transformation matrix corresponding to the candidate benchmark state space model to obtain a correction matrix, wherein some of the first correction parameters correspond to the vibration modes of the first several orders of the candidate benchmark state space model, and the second correction parameters correspond to the transformation matrix of the candidate benchmark state space model; and
taking the correction matrix as the transformation matrix corresponding to the candidate benchmark state space model, obtaining the model accuracy of the candidate benchmark state space model, and continuing the step of judging whether the model accuracy is greater than the target value until the model accuracy is greater than the target value.
